(19) United States
(12) Patent Application Publication
(10) Pub. No.: US 2015/0215289 A1
(43) Pub. Date: Jul. 30, 2015

(54) METHOD FOR HIDING SERVER ADDRESS

(71) Applicant: ELECTRONICS AND TELECOMMUNICATIONS RESEARCH INSTITUTE, Daejeon (KR)

(72) Inventor: Hwan Jo HEO, Daejeon (KR)

(21) Appl. No.: 14/604,355

(22) Filed: Jan. 23, 2015

(30) Foreign Application Priority Data
Jan. 28, 2014 (KR) 10-2014-0010302
Jun. 18, 2014 (KR) 10-2014-0074035

(51) Int. Cl. H04L 29/06

(52) U.S. Cl. CPC H04L 63/0421; H04L 63/1458; H04L 63/0414

(57) ABSTRACT

Provided is a method for hiding a server address including: requesting, by a client, communication with a server to a contact point through a first network path; requesting, by the contact point, communication with the client to the server; and communicating, by the server and the client, with each other through a second network path by encrypting a server address.

### CROSS-REFERENCE TO RELATED APPLICATIONS

This application claims priority to and the benefit of Korean Patent Application No. 10-2014-0010302 filed in the Korean Intellectual Property Office on Jan. 28, 2014, and Korean Patent Application No. 10-2014-0074035 filed in the Korean Intellectual Property Office on Jun. 18, 2014, the entire contents of which are incorporated herein by reference.

### TECHNICAL FIELD

The present invention relates to a method for hiding a server address, and more particularly, to a method for hiding a server address, which includes a contact point on a network apart from a server and transmits data through sequential encryption on a network path.

### BACKGROUND ART

The server-client communication model operating upon an address based communication network assumes that clients acquire the address, of the server in prior to their requests, which will be replied by the server by acquiring their addresses in the request messages, to the server; for example, a web client in the IP (Internet Protocol) communication network should acquire the IP address of the server—the web server which the web client wants to communicate with—first and then sends a HTTP (HyperText Transfer Protocol) message to the server. The IP address of a web server can be directly filled out by a user via the web browser UI (User Interface) or can be acquired by resolving from a domain name, e.g., www.google.com, through a DNS (Domain Name Service) system.

As the address of a server has to be widely informed to clients in the address based server-client communication model, servers can be readily reached by attackers and the addresses cannot be flexibly reconfigured to prevent attacks. Attackers can directly access the server via the well informed server's address to find security vulnerabilities pretending that they are legitimate clients; or attackers can perform DDoS (Distributed Denial of Service) attacks to overload server resources. Switching the address of a server to prevent such attacks not only hinders continuous client service provision but also is very limited since the new address again can be easily acquired by attackers; for example, an attacker who wants to put a DDoS attack against the Google's web server, an IP address of the server can be easily acquired by pinging to the domain name ‘www.google.com’. Therefore, service providers should equip with many servers and IP addresses together with firewalls and IDS (Intrusion Detection System)/IPS (Intrusion Prevention System) to protect their service from such targeted attacks.

### SUMMARY OF THE INVENTION

The present invention has been made in an effort to provide a method for hiding a server address, which minimizes a range of a network area to which the address of the server is exposed so as not to expose the address of the server to the outside.

The present invention has also been made in an, effort to provide a method for hiding a server address, which can flexibly change the address of the server because a client communicates with the server without knowing the address of the server.

The technical objects of the present invention are not limited to the aforementioned technical objects, and other technical objects, which are not mentioned above, will be apparent to those skilled in the art from, the following description.

An embodiment of the present invention provides a method for hiding a server address including: requesting, by a client, communication with a server to a contact point through a first network path; requesting, by the contact point, communication with the client to the server; and communicating, by the server and the client, with each other through a second network path by encrypting a server address.

The second network path may be constituted by a plurality of network nodes to transfer a packet and the first network and the second network path may be different network paths which do not overlap with each other.

The communicating, by the server and the client, with each other may include encrypting, by each of the plurality of network nodes, an address to which the packet is transferred or decoding the address to which the packet is to be transferred based on a unique secret key thereof to transfer the packet.

The communicating, by the server and the client, with each other may include transferring, by the server, a packet including a variable source address field and a fixed destination address field to the client through the plurality of network nodes. For example, the method may further include: by each of the plurality of network nodes, encrypting the variable source address field from the previous network node receiving the packet with the unique secret key; and transferring the packet by configuring the variable source address field by appending a network node address thereof to the encrypted variable source address field.

The communicating, by the server and the client, with each other may include receiving, by the client, an address of the previous network node of the client among the plurality of network nodes. The client may receive a previous network address as a plain text and receive encryption text addresses of intermediate network nodes.

The communicating, by the server and the client, with each other may include transferring, by the client, a packet including a fixed source address field and a variable destination address field to the server through the plurality of network nodes to the server. The method may further include: by each of the plurality of network nodes, decoding the variable destination address field from the previous network node receiving the packet with the unique secret key; and deducing an address of a next network node which each network node is to transfer the packet through the decoding.

For example, the fixed destination address field or the fixed source address field may correspond to an address of the client.

The communicating, by the server and the client, with each other may include transferring, by the server, a connection request completion message to the client and the connection request completion message may be transferred through the first network path or the second network path.

The requesting, by the client, of communication with the server may include transmitting a selective request for the server. The method may further include transferring, by the server, the connection request completion message to the client together with a response to the selective request.

The second network path may include a first gateway at the server side and a second gateway at the client side. For example, the communicating, by the server and the client, with each other may include encrypting or decoding, by each of the first and second gateways, an address of the packet based on a unique secret key thereof to transfer the packet. For example, the first and second gateways may be connected through an IP network or an overlay network.

According to embodiments of the present invention, in communication between a server and a client, a contact point separated from the server is provided and an address of the server is not notified to the client to reduce security elements required to protect the server.

As a result, it is difficult for an attacker to find the address of the server and security equipment can be concentrated on the contact point with the attacker can find the address. Since the security equipment for protecting the contact point is not a path of vast traffic between the server and client, cost can be saved by using equipment having still lower performance and as the existing heavy security equipment between the server and client becomes light, a low-latency and high-bandwidth service can be easily provided.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram illustrating a network structure for implementing a method for hiding a server address according to an embodiment of the present invention.

FIG. 2 is a conceptual diagram for describing a server connection request process of a client C through a contact point R.

FIG. 3 is a flowchart for describing a method for hiding a server address according to an embodiment of the present invention.

FIG. 4 is a flowchart for describing a packet transferring process from a server Sⱼ to a client C.

FIG. 5 is a flowchart for describing a packet transferring process from the client C to the server Sⱼ.

FIGS. 6 and 7 are diagrams illustrating an initial packet transferring process between the client C and the server Sⱼ when the client C transmits a selective request and when not so in order to request connection with the server Sⱼ.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. Like reference numerals refer to like elements in the drawings and a duplicated description of like elements will be skipped.

Regarding the exemplary embodiments of the present invention disclosed in the specification, specific structural or functional descriptions are exemplified to describe the exemplary embodiment of the present invention and the exemplary embodiments of the present invention may be carried out in various forms and it should not be analyzed that the present invention is limited to the exemplary embodiments described in the specification.

Further, terms such as first, second, A, B, and the like may be used in describing the components of the exemplary embodiments according to the present invention. The terms are only used to distinguish a constituent element from another constituent element, but nature or an order of the constituent element is not limited by the terms.

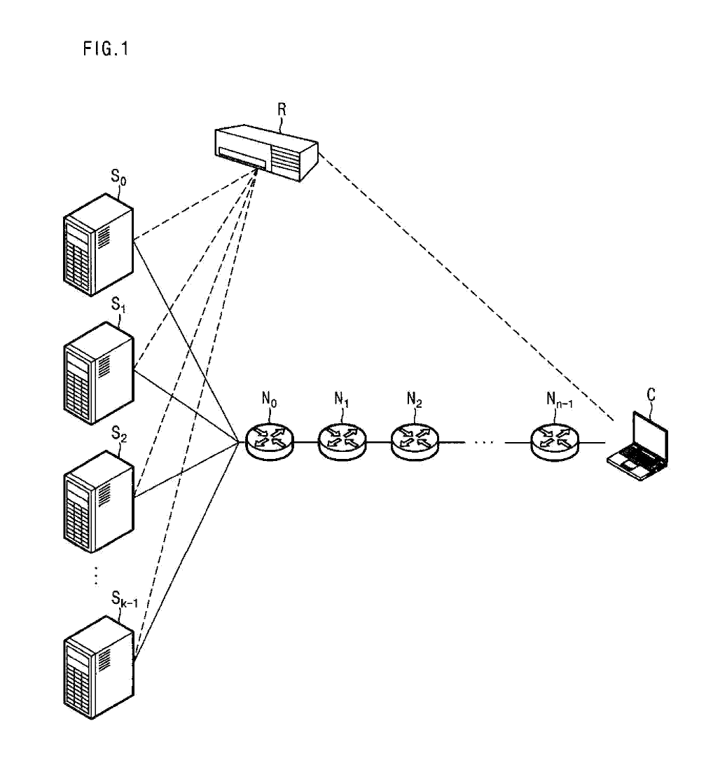

FIG. 1 is a diagram illustrating a network structure for implementing a method for hiding a server address according to an embodiment of the present invention.

Referring to FIG. 1, a separate contact point R is provided when one or more servers S₀, S₁, S₂, . . . , Sₖ₋₁ (hereinafter, referred to as S) operated by a server provider and a client C communicate with each other. Further, the server S and the client C may be connected to each other through multiple network paths N₀, N₁, . . . , Nₙ₋₁.

The contact point R may be positioned on another network which does not overlap with the network paths N₀, N₁, . . . , Nₙ₋₁ through which the server S and the client C are connected to each other.

In the method for hiding the server address according to the present invention, the client C requests connection with the contact point R not the server S. The contact point R selects one server Sⱼ among one or more servers S₀, S₁, S₂, . . . , Sₖ₋₁ provided by the server operator to notify an address of the client C to the selected server Sⱼ and allows the selected server Sⱼ to communicate with the client C.

After initial server-client connection is established, the server Sⱼ and the client C communicate with each other through the network paths N₀, N₁, . . . , Nₙ₋₁. Data transmitted through the network paths N₀, N₁, . . . , Nₙ₋₁ are processed according to an encryption method to be described below. An address of the server Sⱼ is hidden through encryption according to the embodiment of the present invention and the communication is thus enabled while the address of the server Sⱼ is not exposed to the client C.

Connection setting between the server Sⱼ and the client C through the contact point R will be described.

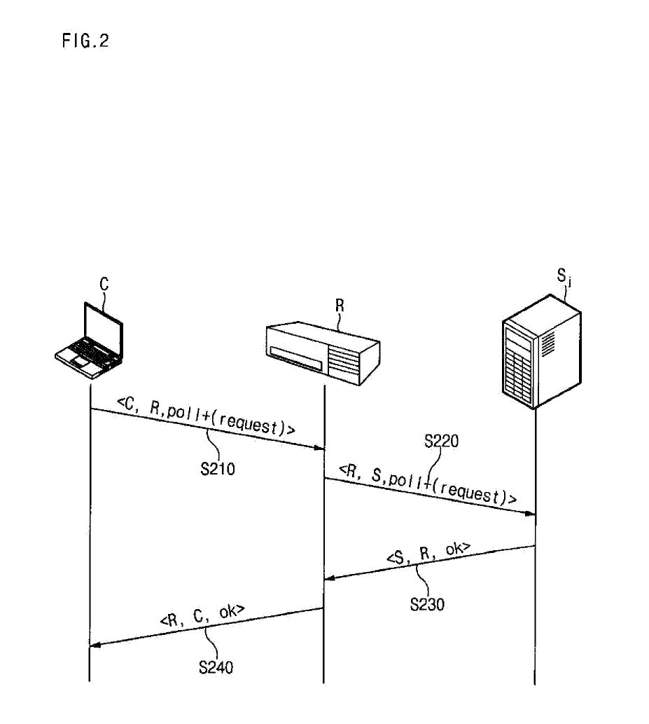

FIG. 2 is a conceptual diagram for describing a server connection request process of a client C through a contact point R. In the specification, a message is expressed as <X, Y, Z>. X represents a source, Y represents a destination, and Z represents contents or a type of the message.

Referring to FIG. 2, the client C transmits a connection request poll message for the server to the contact point R (step S210). The message which the client C transmits to the contact point R has a format of <C, R, poll+(request)>. As described above, the server connection request message may selectively include a request, and for example, HTTP may include an HTTP request.

As compared with the case in which the client C requests the request again after receiving a response to the connection request, when the client C transmits the request together with the connection request, a response process from the server S may be reduced.

The contact point R selects one server Sⱼ among one or more servers S₀, S₁, S₂, . . . , Sₖ₋₁ through predetermined determination logic to selectively transfer the request to the selected server Sⱼ together with an address A_{c} of the client C according to a request from the client C (step S220).

The server Sⱼ may determine the address A_{c} of the client C through a packet received from the contact point R. Further, the server Sⱼ may respond to the request from the client C.

The server Sⱼ selectively transmits a verification message ok for notifying that the connection with the server Sⱼ is completed to the contact point R (step S230) and the contact point R may also transmit the verification message ok for notifying the connection completion to the client C (step S240). When the connection is not completed, an error message is transmitted to allow the connection to be established again.

According to the embodiment, since the connection between the server Sⱼ and the client C is completed first of all, the verification message ok may be transmitted through the network paths N₀, N₁, . . . , Nₙ₋₁ separated from the contact point R.

As described above, since the contact point R is provided for initial connection between the server Sⱼ and the client C, the address of the server Sⱼ is exposed to the contact point R. Therefore, security equipment is concentrated on the network path with the contact point R for security of the address of the server Sⱼ. Since the network path to the contact point R is separated from the network paths N₀, N₁, . . . , Nₙ₋₁ between the server Sⱼ and the client C to transmit only packets for the connection process, the network path is low in traffic. Accordingly, the security equipment embodied for the contact point R according to the present invention may be allowed to have lower performance compared with the related art.

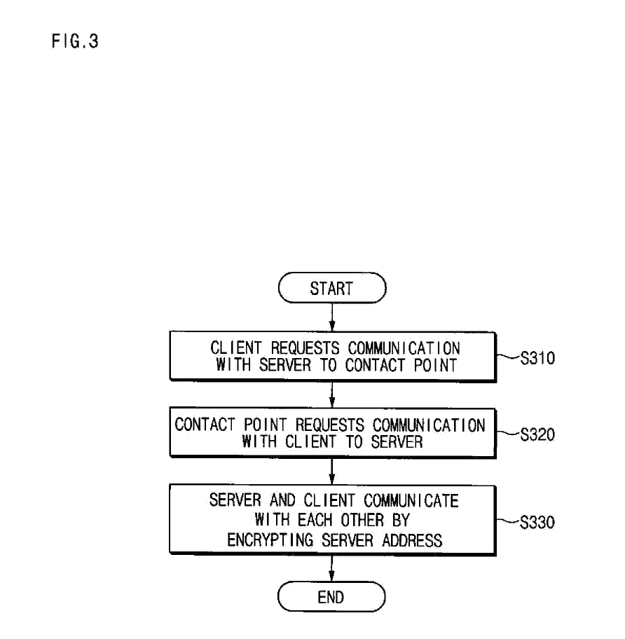

FIG. 3 is a flowchart for describing a method for hiding a server address according to an embodiment of the present invention and comprehensively describes the concept exemplified in detail in FIG. 2.

Referring to FIG. 3, the client C requests communication with the server to the contact point R (step S310, see step S210 of FIG. 2). The contact point R requests communication with the client C to the server Sⱼ in response to the request from the client C (step S320, see step S220 of FIG. 2). The client C may transfer the address A_{C} of the client C to the server Sⱼ. Further, the server Sⱼ may selectively transfer the request from the client C together.

The server Sⱼ responds to the client C through the network paths N₀, N₁, . . . , Nₙ₋₁ according to the connection request from the client C. The address of the server Sⱼ is encrypted in the communication between the server Sⱼ and the client C (step S330). According to the embodiment, each of a plurality of network nodes constituting the network path encrypts an address to which the packet is transferred or decodes an address to which the packet is to be transferred based on a unique secret key to transfer the packet.

Hereinafter, the packet transmission between the server Sⱼ and the client C through the network paths N₀, N₁, . . . , Nₙ₋₁ after the connection with the server Sⱼ is established will be described.

As the network paths N₀, N₁, . . . , Nₙ₋₁ through which the packet passes when the server Sⱼ and the client C communicate with each other, a symmetric path of which both directions are the same may be used. The network path may be configured in various schemes and is determined according to a known path determination scheme used in the network. Accordingly, a detailed description of the determination scheme of the network path will be omitted.

The respective network nodes constituting the network paths N₀, N₁, . . . , Nₙ₋₁ may individually configure the paths according to a network situation. Hereinafter, the network node is referred to as ‘Nᵢ’. When a specific packet is transferred to the network node Nᵢ, each network node determines a next network node to translate an address field. In the specification, the network node that transfers the packet to the corresponding network node is referred to as ‘previous network node’ and the network node to which the corresponding network node transfers the packet is referred to as ‘next network node’ to describe the packet transferring on a sequential network path.

In the present invention, each of n network nodes Nᵢ has a unique secret key Kᵢ. The secret key Kᵢ is used for encryption and decoding and may refer to a symmetric key or a pair of asymmetric keys.

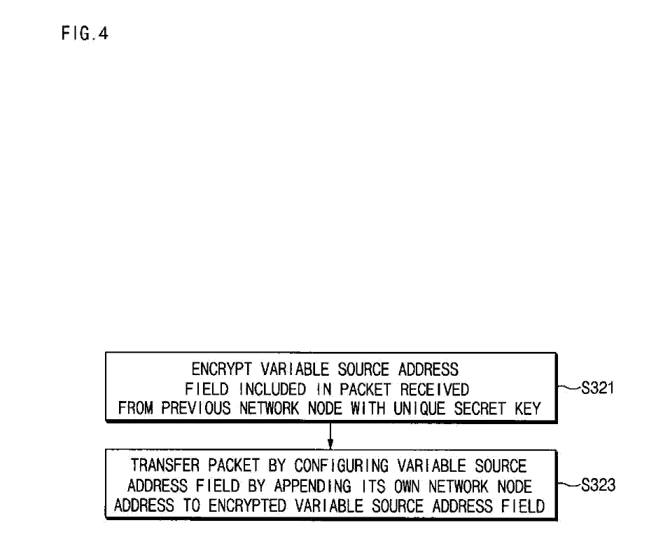

FIG. 4 is a flowchart for describing a packet transferring process from a server Sⱼ to a client C.

The network nodes Nᵢ translate an address value by using the secret key Kᵢ in respects to the packet received from the previous network node Nᵢ₋₁ and transmit the translated packet to the next network node Nᵢ₊₁. Only an address A_{Ni-1} of the previous network node is exposed to the corresponding network node Nᵢ after passing through the multiple network nodes and the previous information is encrypted. The address of the server Sⱼ may be hidden through such a method.

In detail, the packet transferring scheme between the server Sⱼ and the client C will be described. The packet may include two address fields of {address₁ and address₂}. The ‘address₁’ is a variable source address and the ‘address₂’ is a fixed destination address.

When the network node Nᵢ receives the packet from the previous network node Nᵢ₋₁, the network node Nᵢ encrypts the address₁ field of the received packet with a unique secret key Kᵢ thereof (step S321).

The network node Nᵢ configures the address₁ field by appending the address A_{Ni} of the network node Nᵢ and transfers the packet to the next network node Nᵢ₊₁ (step S323). The address₂ field is not translated to the fixed destination address and maintains a value of the address A_{C} of the client C.

Table 1 shows packet conversion through the network nodes Nᵢ between the server Sⱼ and the client C.

TABLE 1

| Network | Next | | |
|---|---|---|---|
| node | network node | Address₁ | Address₂ |
| Sⱼ | N₀ | A_{S}_{₁} | A_{C} |
| N₀ | N₁ | A′_{N}_{₀} = E_{K}_{₀}(A_{S}_{ⱼ})\|A_{N}_{₀} | A_{C} |
| N₁ | N₂ | A′_{N}_{₁} = E_{K}_{₁}(A′_{N}_{₀})\|A_{N}_{₁} | A_{C} |
| . . . | . . . | . . . | . . . |
| N_{n - 1} | C | A′_{N}_{_{n − 1}} = E_{K}_{_{n − 1}}(A′_{N}_{_{n − 2}})\|A_{N}_{_{n − 1}} | A_{C} |

Referring to Table 1, in order for the server Sⱼ to communicate with the client C, the server Sⱼ configures its own address A_{Sj} in the address₁ field and the address A_{C} of the client C in the address₂ field to transfer the addresses to the next network node N₀. The network node N₀ that receives the packet from the server Sⱼ encrypts the received address₁ with the unique secret key K₀. In Table 1, E_{Kj}(P) represents a value acquired by encrypting a predetermined value P having a variable size with the secret key Kⱼ and ‘|’ represents a concatenation binary operator that appends a right value to a left value. When the secret key Kᵢ is the asymmetric key pair E_{Kj}(P) represents a value encrypted by using a key used for the encryption among asymmetric keys.

When the network node N₀ configures the address₁ field by encrypting the received, address A_{Sj} of the server Sⱼ to generate a value of E_{K0}(Aₛⱼ) and appends an address A_{N0} thereof to configure the addressᵢ field, thereby transferring the packet to the next network node N₁.

The network, node N₁ encrypts the received address₁ field with a unique secret key K₁ thereof and appends an address A_{N1} thereof to configure the address₁ field. Since the address of the server Sⱼ is encrypted with the secret key K₁ of the network node N₁ in the address₁ field which the network node N₁ receives from the previous network node N₀, the address of the server Sⱼ may not be found when the secret key K₁ of the network node N₁ may not be found.

Therefore, in regards to the network paths from the network node N₁ to the client C, the address A_{Sj} of the server Sⱼ is not exposed.

Finally, in the case of the packet received by the client C, only the address A_{Nn-1} of the previous network node Nₙ₋₁ is exposed as a plain text and the addresses of the remaining network nodes as well as the server Sⱼ are all encrypted. In particular, the address A_{Sj} of the server Sⱼ is redundantly encrypted with the secret key Kᵢ of all network nodes N₀, N₁, . . . , Nₙ₋₁ through which the packet passes from the server Sⱼ to the client C.

The client C acquires the plain text address of the server Sⱼ and encryption text addresses A′_{Nn-1} of intermediate network nodes.

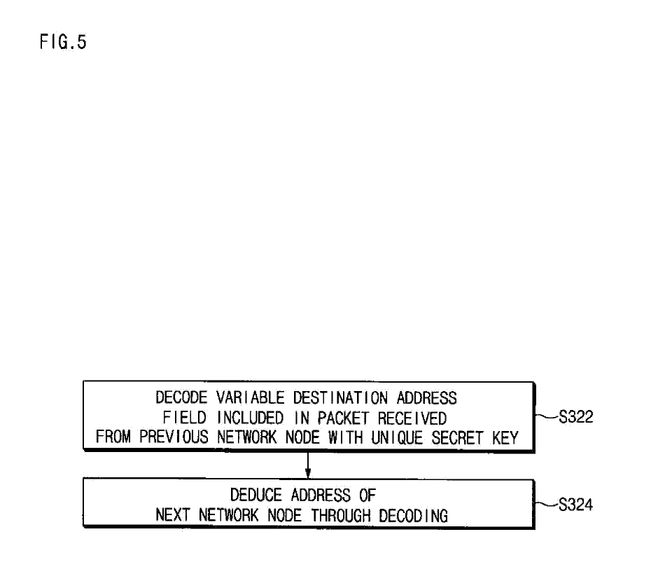

FIG. 5 is a flowchart for describing a packet transferring process from the client C to the server Sⱼ.

The client C that receives the packet from the server Sⱼ transfers the packet to the server Sⱼ by a scheme shown in Table 2. As described above, although the client C does not find the address of the server Sⱼ which is encrypted with unique secret keys of network servers multiple times, the client C may communicate with the server Sⱼ.

TABLE 2

| Network | Next | | |
|---|---|---|---|
| node | network node | Address₁ | Address₂ |
| C | N_{n - 1} | A_{C} | A′_{N}_{_{n − 1}} = E_{K}_{_{n − 1}}(A′_{N}_{_{n − 2}})\|A_{N}_{_{n − 1}} |
| . . . | . . . | . . . | . . . |
| N₂ | N₁ | A_{C} | D_{K}_{₂}(E_{K}_{₂}(A′_{N}_{₁})) = E_{K}_{₁}(A′_{N}_{₀})\|A_{N}_{₁} |
| N₁ | N₀ | A_{C} | D_{K}_{₁}(E_{K}_{₁}(A′_{N}_{₀})) = E_{K}_{₀}(A_{S}_{ⱼ})\|A_{N}_{₀} |
| N₀ | Sⱼ | A_{C} | D_{K}_{₀}(E_{K}_{₀}(A_{S}_{ⱼ})) = A_{S}_{ⱼ} |

When the client C transfers the packet to the server Sⱼ, two address fields {address₁ and address₂} are included in the packet. The ‘address₁’ is a fixed source address and the ‘address₂’ is a variable destination address.

The client C configures the address' field with the address A_{C} thereof and configures in the address₂ field and A′_{Nn-1} which is the address₁ value of the packet received from the server Sⱼ. As described above, A′_{Nn-1} represents the plain text address of the server Sⱼ and the encryption text addresses of intermediate network nodes.

In Table 2, D_{Kj}(P) represents a value acquired by decoding a variable address P with the secret key Kⱼ. When the secret key Kᵢ is the asymmetric key pair, D_{Kj}(P) represents a value decoded by using a key used for the encryption among the asymmetric keys.

When the network node Nᵢ receives the packet from the previous network node Nᵢ₊₁, the network node Nᵢ removes the address A_{Ni} thereof appended to the address₂ field (that is, the aforementioned right value and decodes the value encrypted with the secret key Kᵢ(step S322).

The decoded value includes, as the plain text, the address A_{N1-1} of the next network node Nᵢ₋₁ in addition to address values of subsequent network nodes, which are encrypted with the secret key Kᵢ₋₁ of the next network node Nᵢ₋₁. When the network node Nᵢ decodes the address₂ field of the received packet to deduce the address A_{Ni-1} of the next network node Nᵢ₋₁ to which the network node Nᵢ should transfer the packet (step S324). The network node Nᵢ does not translate the address₁ field and the address₁ field corresponds to the address A_{C} of the client C.

Therefore, each of the network nodes may find only the address of the just next network node, and as a result, the packet is sequentially transferred to reach the server Sⱼ. Consequently, only the network node just before the server Sⱼ finds the address of the server Sⱼ. Accordingly, a range in which the address of the server Sⱼ is exposed is limited.

A configuration generated by n network nodes Nᵢ may be simplified for easiness and efficiency of implementation. For example, two nodes N₀ and Nᵢ become a gateway at the server Sⱼ side and a gateway at the client C side, respectively and a network path between two gateways N₀ and N₁ may be a predetermined network irrespective of the present invention for providing connectivity between the gateways. For example, the network path may be constituted by the existing IP network or an overlay network which is higher than the existing IP network.

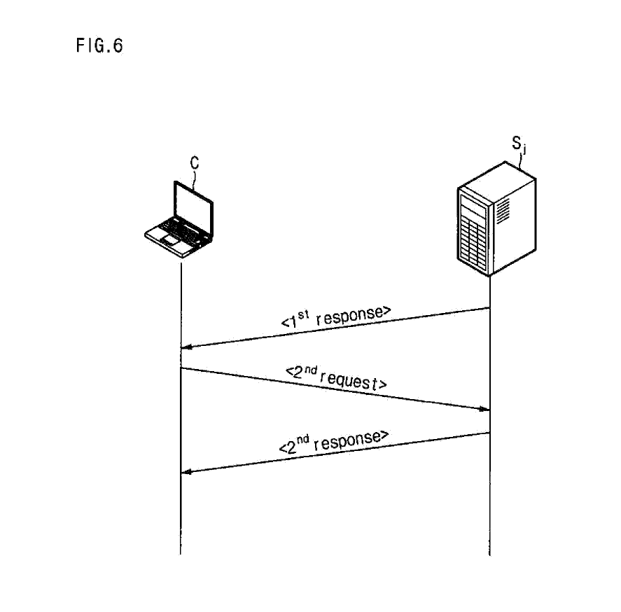

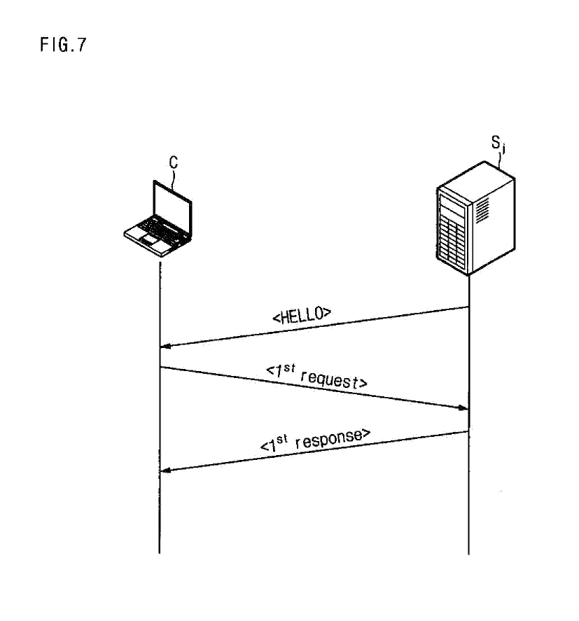

FIGS. 6 and 7 are diagrams illustrating an initial packet transferring process between the client C and the server Sⱼ when the client C transmits a selective request and when not so in order to request connection with the server Sⱼ. The contact point R is omitted in FIGS. 6 and 7 for simple description.

FIG. 6 illustrates the case in which the client C transfers a selective request while requesting a connection to the contact point R.

Referring to FIG. 6, the packet transferred from the server Sⱼ to the client C in an initial connection request may correspond to a 1^{st} request. That is, the client C transfers the request together with the connection request to minimize unnecessary connection request and response processes.

FIG. 7 illustrates the case in which the client C transfers only a simple connection request to the contact point R.

Referring to FIG. 7, when the client C transfers only the connection request to the contact point R, the server Sⱼ transfers a message ‘HELLO’ to the client C. Since there is no separate request, only a message that the connection is established is transmitted and as described above, the encrypted address of the server Sⱼ is included in the address₁ field and thereafter, the client C may thus communicate with the server Sⱼ through the acquired A′_{Nn-1}.

Therefore, the client C transfers the 1^{st} request to the server Sⱼ, and as a result, the client C receives a 1^{st} response from the server Sⱼ.

As compared, with the case of FIG. 6, since two packet transferring processes between the server Sⱼ and the client C are required before receiving the 1^{st} response, a lot of time is required for the connection establishment.

In the method for hiding the server address according to the embodiment of the present invention, since an address which an attacker positioned at the position of the client may find as the plain text is A_{Nn-1} which is an address of an outlet network node Nₙ₋₁ in the case of the configuration generalized by n network nodes Nᵢ which are described above and the address A_{N1} of the client gateway N₁ in the case of the configuration having two gateway nodes N₀ and N₁, the address of the network node, which is known to the client is limited to a network node close to a client distant from the server. Therefore, the server or the network close to the server is less vulnerable to a DDoS attack, and the like.

Although the present invention described as above is not limited by the aforementioned embodiments and the accompanying drawings and it will be apparent to those skilled in the art that various substitutions, modifications, and changes can be made without departing from the technical spirit of the present invention.

What is claimed is:

1. A method for hiding a server address, the method comprising:
requesting, by a client, communication with a server to a contact point through a first network path;
requesting, by the contact point, communication with the client to the server;
communicating, by the server and the client, with each other through a second network path by encrypting a server address.

2. The method of claim 1, wherein the second network path is constituted by a plurality of network nodes to transfer a packet.

3. The method of claim 2, wherein the communicating, by the server and the client, with each other includes encrypting, by each of the plurality of network nodes, an address to which the packet is transferred or decoding the address to which the packet is to be transferred based on a unique secret key thereof to transfer the packet.

4. The method of claim 3, wherein the communicating, by the server and the client, with each other includes transferring, by the server, a packet including a variable source address field and a fixed destination address field to the client through the plurality of network nodes.

5. The method of claim 4, further comprising:
by each of the plurality of network nodes,
encrypting the variable source address field from a previous network node receiving the packet with the unique secret key; and
transferring the packet by configuring the variable source address field by appending a network node address thereof to the encrypted variable source address field.

6. The method of claim 3, wherein the communicating, by the server and the client, with each other includes receiving, by the client, an address of the previous network node of the client among the plurality of network nodes.

7. The method of claim 3, wherein the communicating, by the server and the client, with each other includes transferring, by the client, a packet including a fixed source address field and a variable destination address field to the server through the plurality of network nodes to the server.

8. The method of claim 7, further comprising:
by each of the plurality of network nodes,
decoding the variable destination address field from a previous network node receiving the packet with the unique secret key; and
deducing an address of a next network node which each network node is to transfer the packet through the decoding.

9. The method of claim 1, wherein the first network path and the second network path do not overlap with each other.

10. The method of claim 4, wherein the fixed destination address field or the fixed source address field corresponds to an address of the client.

11. The method of claim 7, wherein the fixed destination address field or the fixed source address field corresponds to an address of the client.

12. The method of claim 1, wherein the communicating, by the server and the client, with each other includes transferring, by the server, a connection request completion message to the client.

13. The method of claim 12, wherein the connection request completion message is transferred through the first network path or the second network path.

14. The method of claim 1, wherein the requesting, by the client, of communication with the server includes transmitting a selective request for the server.

15. The method of claim 14, further comprising:
transferring, by the server, the connection request completion message to the client together with a response to the selective request.

16. The method of claim 1, wherein the second network path includes a first gateway at the server side and a second gateway at the client side.

17. The method of claim 16, wherein the communicating, by the server and the client, with each other includes encrypting, by each of the first and second gateways, an address to which the packet is transferred or decoding the address to which the packet is to be transferred based on a unique secret key thereof to transfer the packet.

18. The method of claim 17, wherein the first and second gateways are connected through an IP network or an overlay network.
